(19) United States
(12) Patent Application Publication
(10) Pub. No.: US 2009/0193100 A1
(43) Pub. Date: Jul. 30, 2009

(54) PRESENTING A LINK TO A MEDIA FILE AUTOMATICALLY SELECTED FOR OPTIMIZED RENDERING ON A CLIENT DEVICE

(76) Inventors: Ahmad Moradi, Ft. Lauderdale, FL (US); Arash Jalali, Ft. Lauderdale, FL (US)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/299,732

(22) PCT Filed: May 7, 2007
(86) PCT No.: PCT/US07/68350

§ 371 Date: Feb. 3, 2009

Related U.S. Application Data
(60) Provisional application No. 60/797,859, filed on May 5, 2006.

(51) Int. Cl. G06F 15/16

(52) U.S. Cl. 709/219; 709/230

(57) ABSTRACT

A system, computer program product and method for automatically presenting a link to a media file is described for a server. The method on a server begins with receiving over a network (114) from at least one client device (122, 125, 126), a plurality of parameters related to media play-back capabilities of the client device (122, 125, 126). The playback parameters includes any of type of media player (432), the device brand and model, player format compatibility, device player compatibility, device protocol compatibility. The method continues by using one or more of these playback parameters for calculating at least one optimization factor based on the parameters which have been received from the client device (122, 125, 126). Next at least media file representing an identical media production but having differing media play-back qualities is selected based on the optimization factor. Finally, without any user intervention, the system presents to the user of the client device (122, 125, 126) a link to the media file which has been selected.

### CROSS-REFERENCE TO RELATED APPLICATIONS

This application is based upon and claims priority from prior U.S. Provisional Application No. 60/797,859, filed on May 5, 2006 the entire disclosure of which is herein incorporated by reference.

### FIELD OF THE INVENTION

This invention generally relates to techniques for displaying audio and/or video media files, and deals more particularly with presenting a link to a media file automatically selected for optimized rendering on a client device.

### BACKGROUND OF THE INVENTION

Podcasting is putting audio files on a web server to make them available for download by a visitor to a website. This idea was later extended to video content and was called video casting.

Podcasting was first introduced as an alternative way to creating weblogs, a.k.a. “blogging”. A weblog is a collection of articles or posts published on a website for any number of purposes. It could be someone's diary, a journalist's independent reports and views, or an author's article posted as part of an online magazine. Whatever the content, weblogs present most of their content in the form of text, occasionally mixed with images and pictures. What makes a weblog distinct from an ordinary web page is that the content grows as more posts are added to the weblog. The posts are made periodically and the intended audience visit the website to find new posts.

As weblogs gained more popularity other concepts and technologies emerged to facilitate easier dissemination of the contents of these weblogs. Notable among these emerging technologies were techniques devised to syndicate content. Content syndication made it possible for other websites as well as individuals to programmatically extract the contents of other websites as new posts or articles are added to them. Really Simple Syndication or RSS, which is an XML based content format, making tagging content possible, was and is still being used to provide a machine readable “feed” of the contents of the site. Individuals as well as organizations could use special software to “subscribe to” and then download the contents of RSS-enabled websites for offline viewing. Core to this technology is the following assumptions:
1) Content from a source, be it a weblog or a news agency's website, is updated periodically. There needs to be a mechanism to decide if new items—i.e. weblog posts, magazine articles, news headlines, etc.—have been posted.
2) The content should be presented in way that allows for it to be machine-readable, very much the way people read their own email or download new posts to USENET newsgroups.
3) The content, irrespective of the licensing scheme, should be downloadable for offline viewing. In the case of a website-to-website syndication, offline viewing would mean that the content extracted from the source website should be partially or wholly accessible on the “subscribing” site regardless of whether that source site continues to maintain that content in the future. This calls for the source content to be downloadable, as opposed to be able to just “link” to the original source.

Podcasting was born as a media-rich alternative to simple “blogging”. Instead of articles being typed and presented as text, the weblog owner would speak the words and record them in a digitally presentable format, such as an MP3 file. The visitors of the weblog would then be able to “listen” to the posts instead of reading them. They could also download the audio file for offline listening. This is the most basic form of podcasting which can be turned into video casting by simply replacing the audio file with video files.

With this background, podcasting quickly adopted the technologies and methods already devised for text-based syndication. Extensions to the RSS, i.e. RSS version 2.0, made provisions for “enclosures”. Enclosures are simply links for downloadable audio or video files. Just as RSS reader software was devised to allow users to see available new items on a weblog or a news site, and then selectively download their full text, podcasting programs were developed to allow users to subscribe to different sites, see the latest items available, and selectively download the “enclosed” video or audio file for offline viewing or listening. Podcasting and later video casting went beyond simple blogging. TV stations, radio stations, artists, as well as online music and video stores started using the technology to provide free or licensed content to their viewers.

Apple's iTunes music store is still using this technology to this day, to provide the available items of music for sale directly the user's music player software. The iTunes media manager software from Apple Computers, which is available for Macintosh and Windows platforms, is capable of digesting RSS formatted podcasts and then selectively downloading and playing the enclosures.

In fact, many end users nowadays define podcasting as a mechanism that allows them to get the latest media item (be it the daily news or music) from the Internet through their PC's and save them to their iPod, or a device with similar functionality.

Although podcasting is useful, it is not without its challenges and shortcomings. For instance there are still several technical as well as consumer-related issues that make podcasting difficult to use

One challenge is that many users are still new to podcasting. In a poll conducted by the German radio and television company, Deutsche Welle, on their website, about 20% of the participants stated that they do not even know what podcasting is and 37% knew what it was but were not podcasting subscribers. One could attribute this to the fact that podcasting is still a new technology and that the process for subscribing to podcasting sources is still not very smooth: The users should first have a podcasting software installed. There are so few of them, that major websites such as CNN.COM actually offer link to specific software programs (like iTunes, iPodder and Juice) that allows them to use podcasting.

Another challenge is that podcasting links are not that much integrated into web-browsers. At best, many browsers see the podcasting links as yet another RSS feed and do not even offer connectivity with podcasting software let alone direct download and connectivity to hand-held players. Users must copy the URL of the podcasting link and then manually run their podcasting software and paste the URL into it. In a sense subscribing to a new podcasting source is still a matter of switching between two separate worlds.

Still another shortcoming is that whenever rich media is involved, the question of codec compatibility is also present. Different devices and software packages are capable of playing back different types of audio and video codec's. The issue is less serious when it comes to audio. Most of today's podcasting is done using the MP3 format and almost all audio play back devices and programs are capable of playing MP4 nowadays. The question of bit-rate however remains. The higher the bit-rate of an audio recording, the larger the file will be and therefore the more time one needs to download the file.

The situation is much more complex when it comes to video casting. There is more variety when it comes to video codec's and apart from the codec, the video size is also an issue for play-back devices, because it should conform not only with the screen size specification of the hand-held device the video is going to be played back, there are also device, mobile phones in particular, which can only play back movies that are recorded with a certain number of frames per second. Movies with more frames per second than the specified limit will not be fast enough to render the consecutive frames in time.

Prior art solutions provide just a link to a video or audio file. Not a link optimized to a user's device. Stated differently, prior art solutions provide the same link no matter what device is visiting the webpage. The link is the same no matter the connection speed or software installed on the user's device.

According what is needed is a method and system to make mediacasting easier for a user of a client device by providing the correct link to a media file automatically selected for optimized rendering on the client device.

### SUMMARY OF THE INVENTION

The present invention overcomes the shortcoming and challenges of the prior art mediacasting system. The present invention provides a system, computer program product and method for automatically presenting a link to a media file. The method on a server begins with receiving over a network from at least one client device, a plurality of parameters related to media play-back capabilities of the client device. The playback parameters includes any of type of media player, the device brand and model, player format compatibility, device player compatibility, device protocol compatibility. The method continues by using one or more of these playback parameters for calculating at least one optimization factor based on the parameters which have been received from the client device. Next at least media file representing an identical media production but having differing media play-back qualities is selected based on the optimization factor. Finally, without any user intervention, the system presents to the user of the client device a link to the media file which has been selected for optimized viewing on the client device.

In another embodiment, the present invention automatically provides a link to a media file selected for optimized rendering on the user's client device by providing a link directly to a media file to present to the user.

In another embodiment, the present invention automatically provides a link to a media file selected for optimized rendering on the user's client device by providing a link directly to a media file that is compatible with a podcast.

In yet another embodiment, the present invention automatically provides a link to a media file selected for optimized rendering on the user's client device by providing a link to a content description file meta information about the media file. Examples of a meta information includes presenting a link to a content description file that conforms with web feed formats, including but not limited to Really Simple Syndication (RSS) and ATOM.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIG. 1 is a prior art system diagram of media files being delivered to users of client devices from a web server through a hyperlink;

FIG. 2 is a prior art system diagram of media files being delivered to users of client devices such as RSS over a network;

FIG. 3 is a screen shot of a prior art system illustrating a link which does not change depending on the parameters of the client device being connected;

FIG. 4 is a block diagram illustrating an exemplary information processing system environment according to an embodiment of the present invention;

FIG. 5. is a flow chart illustrating the acts or steps for automatic selection of a media file according to the present invention; and

FIG. 6 is screen shot of a system illustrating a link which automatically changes depending on the parameters of the client device being connected, according to the present invention.

### DESCRIPTION OF THE PREFERRED EMBODIMENTS

The present invention as would be known to one of ordinary skill in the art could be produced in hardware or software, or in a combination of hardware and software. However in one embodiment the invention is implemented in software. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art.

The present invention improves the mediacasting process by automatically selecting, without any user intervention, a link to the media file which has been selected for optimized viewing on the client device. The present invention queries one or more parameters related to media play-back capabilities of the client device. The playback parameters includes any of type of media player, the device brand and model, player format compatibility, device player compatibility, device protocol compatibility. A link to a media file automatically selected for optimized viewing is presented. without any user intervention. The present invention in one embodiment presents a link directly to the selected media file, and in another embodiment, the present invention provides a link to a content description file, containing meta-information about the media file. Examples of content description/syndication file formats include, but are not limited to, those compatible with Really Simple Syndication (RSS) and ATOM.

Definitions and Terminology

The following are definitions of several terms used in this patent.

Mediacasting as used herein is used to describe the process of making pre-recorded audio and/or video content available for downloading over an internet-like computer network. The media content is typically “tagged” or augmented with textual meta-information that describes the media content in more detail. The nature of the media content is such that the content belongs to a generic category that is expected to be updated periodically. Examples of such categories are news items, online magazine articles, postings of a weblog, TV or radio programs, etc. This periodic updatability of the media content implies a need to a “subscription” process, through which the audience could hook up or connection to a fixed named resource to get a “feed” of the latest items available for download. The ultimate goal in mediacasting is for the content to be downloaded by the visitor and viewed or listened to offline, possibly but not necessarily on a device other the one originally used to download the content.

Intelligent mediacasting as used herein is the process through which specific media content is made available for podcasting or videocasting according to individual configurations of the visitor's network connection and the user's computer and/or viewing device.

Media File as used herein is any file containing audio or video information that is to be delivered to an intended audience over a computer network supporting conventional web application protocols, such as HTTP, HTTPS, and more.

Media Clip as used herein is a specific video or audio content materialized in digital format and in several “versions” or “incarnations”, each version being slightly different from other in terms of technical specification but identical as regards the basic underlying (video and audio) content presentation.

Visitor as used herein is an individual or end user presumed to be an authorized audience of a particular media clip that has issued a request to visit that media clip through a web browser on a client device.

Publisher as used herein is the individual(s) responsible for the production and posting of a media clip, including any of its versions over the underlying network. The Publisher is presumed to be in control and in charge of the media clip, and is therefore allowed to modify, delete, or publish the content at his or her discretion.

Mediacasting System

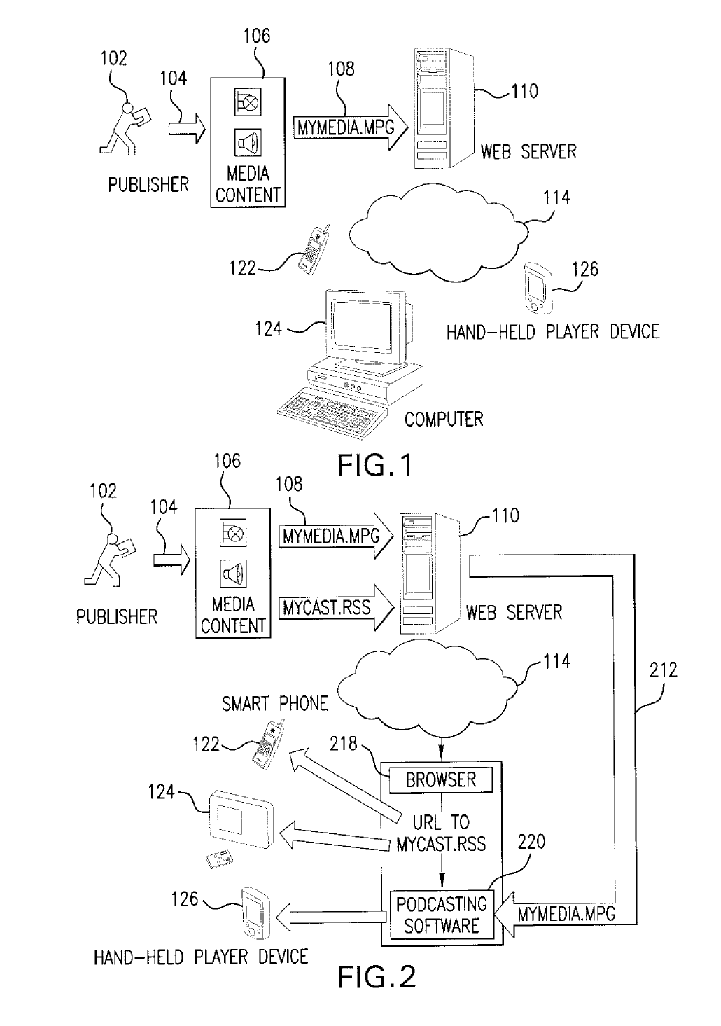

Mediacasting, be it podcasting or videocasting, is performed through either of two processes. In its simplest form, it only involves providing a direct hyperlink to the media file, allowing the visitor to download it. In the more sophisticated method, a link it provided to an RSS document which contains meta-information as well as the URL to the media file media file. The RSS document is suitable for subscription purposes since it can be fed into podcasting software for synchronization and selective downloading of the enclosure. These are shown in FIGS. 1 and 2. Specifically, FIG. 1 illustrates a prior art system diagram of media files being delivered to users of client devices from a web server through a hyperlink and FIG. 2 illustrates a prior art system diagram of media files being delivered to users of client devices such as RSS over a network.

Turning to FIG. 1 shown is a mediacasting architecture from content preparation to content publication. A publisher 102 places one or more media clips 106 such as MPG files on web server 110. One or more end user devices, wireless phone 122, computer 125, and PDS 126 access a link on the webserver through a global communications infrastructure 114 such as the worldwide web. Each of the end user devices are presented the identical link to the media file no matter the characteristics or parameters of the end user device. This is a one media clip type fits all devices model.

FIG. 2 has mediacasting architecture of FIG. 1 adapted for RSS. As shown in FIG. 1, a publisher 102 places media clips 106, including audio and video content on web server 110. A page with the content 106 is accessed through the global communication infrastructure 114 with a web browser 210 compatible with a RSS. The web browser 210 resides on one or more end user devices, wireless phone 122, computer 125, and PDS 126. A link between the webserver 110 and end user device podcasting software 212 is also shown.

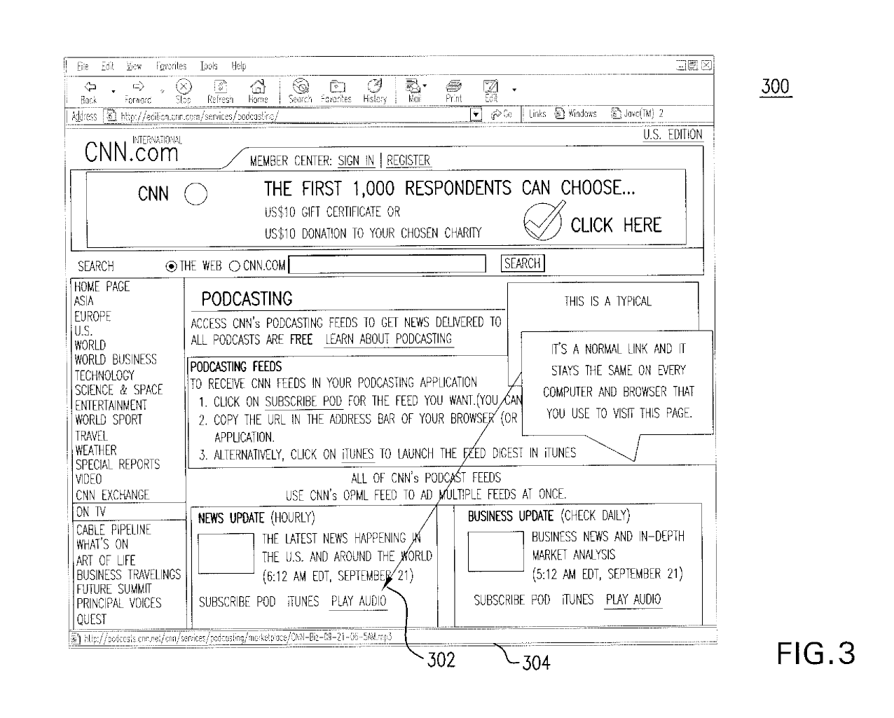

FIG. 3 is a screen shot 300 of a prior art system of FIGS. 1 and 2 illustrating a link 302 which does not change depending on the parameters of the client device being connected, Stated differently, in this podcast link from CNN's website. The direct-download link 302 is the same regardless of what platform e.g., computer, OS, browser, and network bandwidth a visitor of the page is using. For clarity and completeness, the hypertext with the link 302 is shown in the bottom of the window 300 as 304.

Intelligent mediacasting involves the adaptation of the media content to the visitor's platform configuration. Configuration here means: a) the network connection bandwidth, and b) the hardware software configuration of the computer and/or the viewing device (e.g. handheld media player device, smart phone, etc.)

The processes depicted in FIG. 1 are also supported in the intelligent mediacasting in basically the same way. The present invention in one embodiment has instead of one media file, a group of files acting as different versions of a single media clip, each specially tailored to a specific end user device configuration. The Intelligent mechanism automatically selects which version to present as the downloadable file based on the configuration detected on the end user's device.

Aside from this method, intelligent mediacasting also supports a visitor-guided mediacasting which allows the visitor to specify the specifications of the device on which the downloadable file will be saved for off-line viewing or listening.

This feature has been added because as shown in FIG. 1, it is possible that the downloaded media file is not played directly on the computer through which the file has been downloaded; instead, the visitor downloads the file, transfers it to his/her hand-held device (iPod, mobile phone, media player flash memory, etc.) to later view or listen to the contents. In this case, the information obtained through automatic plug-in detection will not be useful as the information reflects the configuration of the computer and not the hand-held player device. In such cases, the visitor must be given the option to select the available formats. The present invention automatically provides a link to file(s) with the specified format.

Information Processing System

According to the inventive principles as disclosed in connection with the preferred embodiment, the invention and the inventive principles are not limited to any particular kind of computer device or information processing system 400 but may be used with any general purpose computer, as would be known to one of ordinary skill in the art, arranged to perform the functions described and the method steps described. The operations of such a computer, as described above, may be according to a computer program contained on a medium for use in the operation or control of the computer, as would be known to one of ordinary skill in the art. The computer medium, which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, Flash memory, floppy disk, Disk drive memory, CD-ROM, and other permanent storage. Additionally, a computer readable medium may include, for example, volatile storage such as RAM, buffers, cache

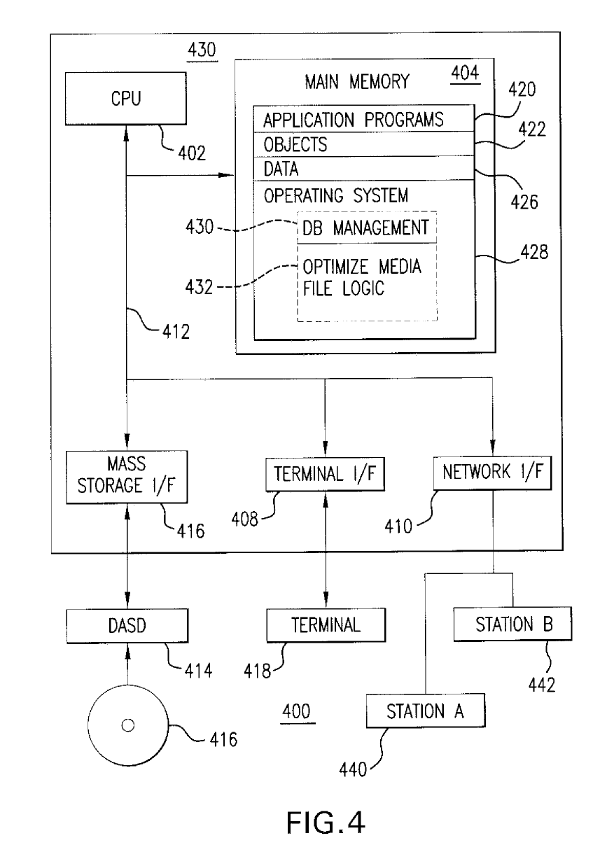

FIG. 4 is a block diagram illustrating a more detailed view of an information processing system 400 according to an embodiment of the present invention. The information processing system is based upon a suitably configured processing system adapted to implement the exemplary embodiment of the present invention. Any suitably configured processing system is similarly able to be used as the information processing system 400 by embodiments of the present invention such as an information processing system residing in the computing environment of FIG. 1, a server, web sever, streaming server, or the like.

The information processing system 402 has a processor 402 that is connected to a main memory 404, mass storage interface 416, terminal interface 408, and network adapter hardware 410. A system bus 412 interconnects these system components. The mass storage interface 416 is used to connect mass storage devices, such as data storage device 414, to the information processing system 400 system. One specific type of data storage device is a computer readable medium such as a DVD drive, which may be used to store data to and read data from a DVD 416. Those skilled in the art will appreciate that embodiments are capable of being distributed as a program product via CD or DVD 416 or other form of non-volatile media, or via any type of electronic transmission mechanism. Another type of data storage device is a data storage device configured to support, for example, NTFS type file system operations.

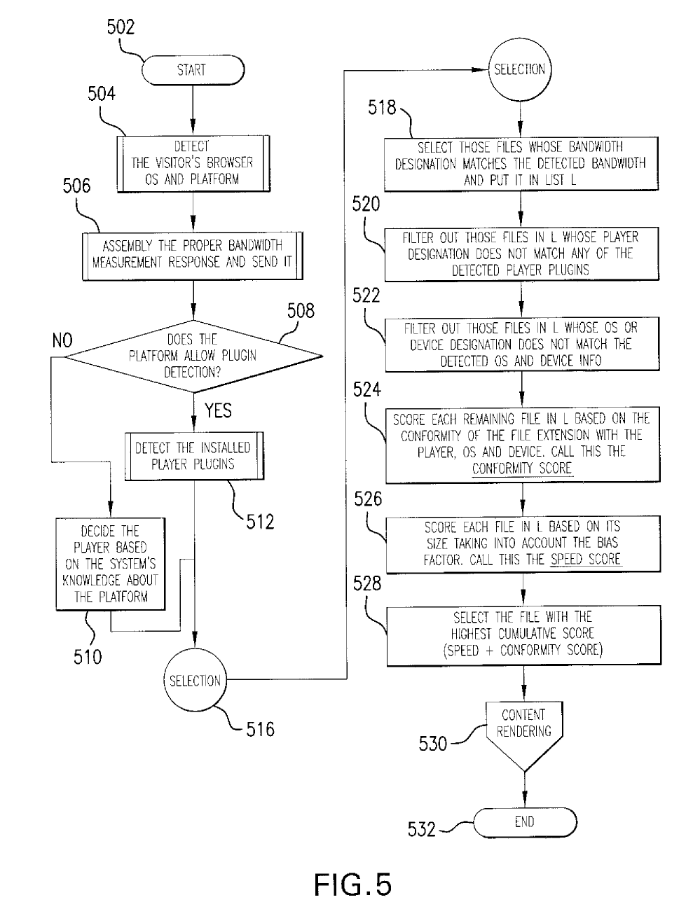

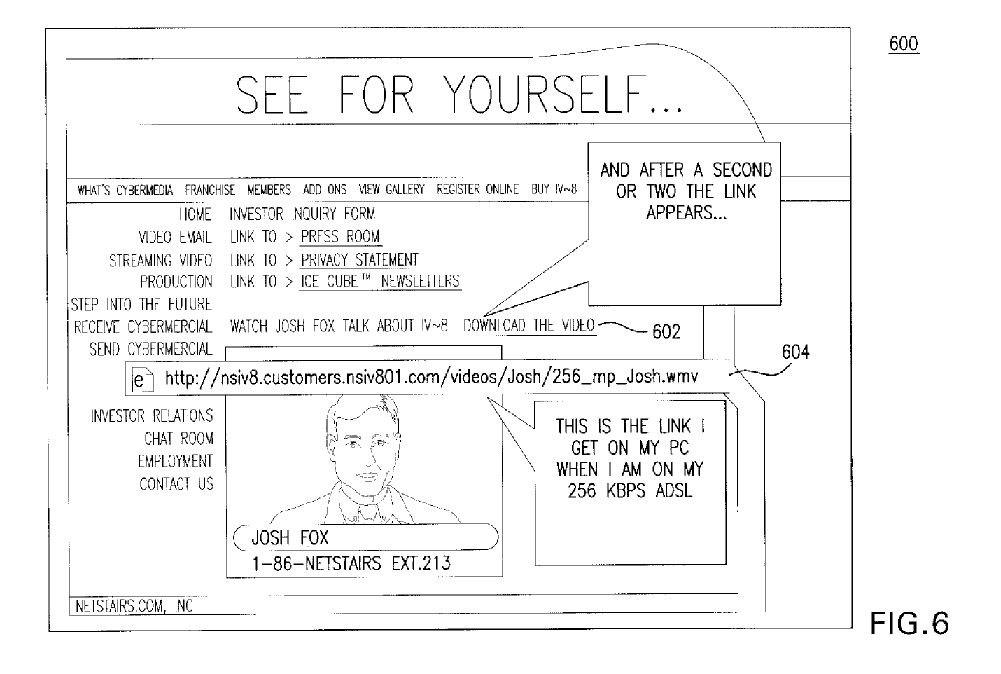

The main memory 404, in one embodiment, comprises one or more database management systems (“DBMS”) 430. The Optimized Media Filed Logic 432 works in conjunction with Application Programs 420, Programming Objects 422, and Data 426 to identify the user's device parameters. Using one or more parameters of the user's device, the correct media clip is retrieved from the Database Management 430 interface and presented and a link presented to the user. This is explained in further detail with reference to FIG. 5 and FIG. 6.

Although only one CPU 402 is illustrated for computer 400, computer systems with multiple CPUs can be used equally effectively. Embodiments of the present invention further incorporate interfaces that each includes separate, fully programmed microprocessors that are used to off-load processing from the CPU 402. Terminal interface 408 is used to directly connect one or more terminals 418 to computer 400 to provide a user interface to the computer 400. These terminals 418, which are able to be non-intelligent or fully programmable workstations, are used to allow system administrators and users to communicate with the information processing system 400. The terminal 418 is also able to consist of user interface and peripheral devices that are connected to computer 400 and controlled by terminal interface hardware included in the terminal I/F 408 that includes video adapters and interfaces for keyboards, pointing devices, and the like.

An operating system (not shown) included in the main memory is a suitable multitasking operating system such as the Linux, UNIX, and Windows Server operating system. Embodiments of the present invention are able to use any other suitable operating system. Some embodiments of the present invention utilize architectures, such as an object oriented framework mechanism, that allows instructions of the components of operating system (not shown) to be executed on any processor located within the information processing system 400. The network adapter hardware 412 is used to provide an interface to a network 438. Embodiments of the present invention are able to be adapted to work with any data communications connections including present day analog and/or digital techniques or via a future networking mechanism.

To optimize the viewing as well as the download experience of a visitor, it is natural to think of the media content as a collection of media files each representing the same content produced to fit certain technical specifications such as codec, resolution, bit-rate, and more, hence the concept “media clip” as defined in the previous section.

Flow Chart

Turning now to FIG. 5. shown is a flow chart illustrating the acts or steps for automatic selection of a media file according to the present invention. The process begins with at step 502 and immediately proceeds to step 504 where a detection of the end user's device browser, Operating Systems and platform parameters are determined. Details on how to detect the parameters of the end user device is taught in co-pending patent application US20050165849 with inventors to Moradi et al. and US20050097615 with inventors to Moradi et al. have been shown to be used advantageously with the present invention and are hereby incorporated by reference in their entirety.

Once the end user device parameters are assembled, a test is made to see if the end user device allows browser plug-in detection. This is important because several cellular telephones and PDA do not allow querying of the browser plug-in type. In response to detection not being possible, a query of through database manager 430 tries to match the known characteristics of the device including make, model, manufacturer, and other variables used to select the proper media file. In response to detection being possible, parameters regarding available plug-ins on the end user device are gathered. At this point all the parameters have been measured and gathered from the end user device at step 516. Next, in step 518, the optimized media file logic 434 selects which media file matches the detected parameters from the end user device. In one embodiment, the parameters include the bandwidth of the connection between the webserver 400 and the end user device 122, 124 and 126. Continuing further, those media files which are not compatible with the detected plug-in are filtered out in step 520. Next those media files which are not compatible with operating system and other device information are filtered out in step 522. Each remaining media file is scored in 524. Again details of this scoring are described in the co-pending applications in co-pending patent application US20050165849 and US20050097615 and are hereby incorporated by reference in their entirety. Also a speed score in step 526 is included. Finally a link to the media file which has been automatically selected in step 528 is displayed to the user of the client device and the process begins rendering the content in step 530 before ending in step 532.

The Intelligent media selection algorithm solves the need in the prior art to adjust and fit media, and particularly video, content to the specifications of the viewer's hardware, software and network platform. In one embodiment, the present invention using an automatic algorithm suggested a mechanism, given a group of files with different codec's and bit-rates, to decide which file has the highest chance of successfully and seamlessly playing for the viewer.

The parameters taken into consideration include the visitor's network connection bandwidth and the media player software detected to have been installed on the visitor's computer.

In one embodiment, each media file is designated to a particular bandwidth and media player. For example a file named 768_mp_myvideo.wmv is associated with the 768 Kbps bandwidth and the Windows Media Player software.

As described above, the algorithm used in FIG. 5 operates in two phases: detection, and selection. In the detection phase the algorithm attempted to detect and/or measure the parameters mentioned above. In the selection phase, the algorithm first selects a number of “candidates” with designations that conforms to the parameters detected in the first phase. The candidates are then scored based on how well the file types conformed to the detected players as well as with how much better download performance they could be delivered to the visitor. The performance measurement could be biased using a user-defined parameter called the “bias factor” in favor of faster download speed or better playback quality. Eventually the candidate with the highest score was chosen to be delivered to the visitor.

It is important to note, that the algorithm increases the number of parameters that need to be taken into account and offers more flexibility in defining file designations. Specifically, the algorithm in one embodiment support mobile devices. With the he added parameters of player version, operating system, device brand and model, player-format compatibility, device-player compatibility, device-protocol compatibility.

Although the present invention detection algorithm may rely on the information provided by the designations specified by the user (i.e. the owners/publishers of videos). In this embodiment internal information of the end user device assists in selecting the candidate media files and narrowing them down to the best candidate through scoring.

The present invention in one embodiment detects:
what file formats are supported by each version of a certain type of player.
what hand-held device versions support media playback and what players come pre-installed with each hand-held device.
what protocols are supported by each hand-held device and each player version.
what codec and file formats each particular hand-held device model (or brand) supports.

The present invention in one embodiment uses a file naming convention with formal grammar rules define the new file naming syntax:

<File-Name> ::= <Bandwidth>_<Player>[-<Platform>]_<Folder-
Name>.<Extension>
<Bandwidth> ::= lan | 1500 | 768 | 512 | 384 | 256 | 56
<Player> ::= <Player-Name>[.<Version>]
<Player-Name> ::= mp | rp | qt | fl | any
<Version> ::= <digit>(.<digit>+)*
<Platform> ::= <OS>[-<Device>]
<OS> ::= any | <OS-Name>[.<Version>]
<Device> ::= <Brand>[<Model>] | any

As is evident from the grammar rules above, the new algorithm allows for “wild card” designations. This will ease the job of the human operator by relieving them of having to be precise on designations. A file can be designated to “any” player, as it can be designated to a specific player on “any” platform.

In the previous section the overall process that intelligently provides a visitor with a podcasting or videocasting content was described. In this section, the methods and techniques through which intelligent podcasting can be embedded into a user's (media owner's) web site is described.

In mediacasting the visitor or end user is ultimately be provided with a direct hyperlink to a specific media file or an RSS file. The link might be clicked on by the visitor to view or listen to the content as it downloads, or it might be used to only download the content and saved on the visitor's local hard disk.

Since this link will ultimately point to different actual files depending on the visitor's configuration, the URL of the link cannot be hard-coded into the web-page. Instead the URL should “built” for each individual visitor. This URL building can happen in either a single-step or a two-step process.

In the single step process, the HTML code piece that displays the link is built automatically whenever the containing web-page is visited. The resulting web page would look to the visitor as if the link has been hard-coded into the page because the containing web-page and the mediacasting link are rendered in parallel.

In the two-step process, the mediacasting links are in fact links to the intelligent mediacasting backend. Unlike the single-step method, the intelligent mediacasting back-end mechanism is not activated automatically every time the web page is visited. Instead the visitor should manually trigger it. The mechanism will then display a separate page (a new window and/or a pop-up) that contains the actual mediacasting link.

FIG. 6 is screen shot 600 of a system illustrating a link 302 which automatically changes depending on the parameters of the client device being connected, according to the present invention. The mediacast link is dynamically chosen by the optimized media file logic 432. For clarity and completeness, the hypertext with the link 602 is shown in the bottom of the window 600 as 604.

It might seem that the two-step process is redundant as it is always preferred to offer visitors a process that requires a minimal number of clicks. The two-step mechanism has been provisioned in the intelligent mediacasting techniques for two reasons:
1. The visitor's browser might not support content embedding mechanisms such as frames or in-line frames. Therefore it might not be possible to trigger the intelligent back-end simultaneously with the rendering of the containing web page. This is especially true for certain hand-held web-enabled devices such as PDA's whose browsers support only a subset of the HTML tag set.
2. A page containing multiple mediacasting links would take considerably longer to fully load if it is filled with single-step mediacasting links. The two-step process defers the delays incurred by the intelligent bandwidth and configuration detection algorithm until it is actually needed.

High Level Overview of Mediacast Process

The visitor using end user device visits the web page containing the intelligent mediacast.
1. The visitor clicks on the podcast “download” link. The link points to the intelligent detection and selection backend program.
2. Visitor's bandwidth and software/hardware configuration is detected through the algorithm discuses previously.
3. The backend will select the best scoring candidate among the files available under a specific media clip.
4. The visitor can then click on the link to download the file.

High Level Overview of RSS Process with Podcasting Software

The visitor using end user device visits the web page containing the intelligent mediacast.
1. The visitor visits the page that contains a “subscribe” hyperlink pointing to the intelligent mediacasting back program.
2. The visitor clicks on the subscribe link, causing the browser to send a request to the back end for an RSS document for a specific media clip.
3. The backend analyzes the request, and tries to detect the visitor's network connection bandwidth and other configuration parameters according to the algorithm explained in the chapter 1.
4. The backend sends an HTML response containing a link to an RSS-builder page. The link tells the RSS builder which media clip should be used to make the meta-information in the RSS document along with the highest scoring media file selected in chapter 3 as enclosure.
5. The visitor can then copy and paste the RSS builder link to his/her own podcasting software.
6. The visitor using end user device visits the web page containing the intelligent mediacast.

High Level Overview of Visitor-Guided Mediacast Process

The visitor using end user device visits the web page containing the intelligent mediacast.
1. The visitor visits the page that contains a “custom podcasting” hyperlink pointing to the intelligent mediacasting back program.
2. The backend program then composes a response that asks the visitor to select any of available formats for the podcast.
3. The visitor selects the format that best suits their off-line hand-held player device.
4. The backend sends an HTML response containing a link to an RSS-builder page. The link tells the RSS builder which media clip should be used to make the meta-information in the RSS document along with the media file whose format conforms with what the visitor has specified in step 3.
5. The visitor then copies and pastes the hyperlink URL into their podcasting software to download the meta-information and the enclosure that is suitable for the visitor's offline player device.
   The webs server 400 sends an HTML response containing a link to an RSS-builder page. The link tells the RSS builder which media clip should be used to make the meta-

[symbol]

Advantages of the Present Invention

The podcast link is intelligently adapted to the viewer's connection and player configuration No need to develop or host any server side programs on your website. A small piece of HTML into your page to receive an intelligent podcast which provides a seamless experience to end users. The present invention has been shown to work advantageously with all web browsers and provides more ways to present your podcast: Popup window, as well as “Linklet”s that get activated by the visitor's click. The present invention supports symbaian and PocketPC-based viewers and other viewers.

Non-Limiting Examples

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A method on server for automatically presenting a link to a media file, the method comprising:
receiving over a network from at least one client device, a plurality of parameters related to media play-back capabilities of the client device;
calculating at least one optimization factor based on the parameters which have been received from the client device;
selecting, based on the optimization factor, one from at least media file representing an identical media production but having differing media play-back qualities; and
presenting to a user of the client device a link to the media file which has been selected.

2. The method according to claim 1, where in the presenting to the user of the client device a link to the media file includes presenting a link directly a media file to present to the user.

3. The method according to claim 2, where in the presenting to the user of the client device a link to the media file includes presenting a link directly a media file that is compatible with a podcast.

4. The method according to claim 1, where in the presenting to the user of the client device a link to the media file includes presenting a link to a content description file, containing meta-information about the media file.

5. The method according to claim 4, where in the presenting to the user of the client device a link to the media file includes presenting a link to a content description file is compatible with at least one web feed format of Really Simple Syndication (RSS) and ATOM.

6. The method according to claim 1, where in the receiving over a network from at least one client device, a plurality of parameters related to media play-back capabilities of the client device include network bandwidth to the client device and type of media player on the client device.

7. The method according to claim 1, where in the receiving over a network from at least one client device, a plurality of parameters related to media play-back capabilities of the client device include device brand and model.

8. The method according to claim 1, where in the receiving over a network from at least one client device, a plurality of parameters related to media play-back capabilities of the client device include player format compatibility

9. The method according to claim 1, where in the receiving over a network from at least one client device, a plurality of parameters related to media play-back capabilities of the client device include device player compatibility.

10. The method according to claim 1, where in the receiving over a network from at least one client device, a plurality of parameters related to media play-back capabilities of the client device include device player compatibility.

11. The method according to claim 1, where in the receiving over a network from at least one client device, a plurality of parameters related to media play-back capabilities of the client device include device protocol compatibility.

12. The method according to claim 1, where in the presenting to the user of the client device a link to the media file includes embedding a link in a webpage through use of scripting code, without altering any other information on the webpage.

13. A server adapted to automatically presenting a link to a media file, the server comprising:
a network interface adapted to receive over a network from at least one client device, a plurality of parameters related to media play-back capabilities of the client device;
a storage medium readable by a processing circuit and storing instructions for execution by the processing circuit for
calculating at least one optimization factor based on the parameters which have been received from the client device;
selecting, based on the optimization factor, one from at least media file representing an identical media production but having differing media play-back qualities; and
presenting to a user of the client device a link to the media file which has been selected.

14. The server according to claim 13, where in the link to the media file includes a link directly a media file to present to the user.

15. The server according to claim 13, where in the link to the media file includes a link directly a media file that is compatible with a podcast.

16. The server according to claim 13, where in the link to the media file includes a link to a content description file meta information about the media file.

17. The server according to claim 16, where in the link to the media file includes a link a content description

18. A computer program product for automatically presenting a link to a media file, the computer program product comprising computer instructions for:
receiving over a network from at least one client device, a plurality of parameters related to media play-back capabilities of the client device;
calculating at least one optimization factor based on the parameters which have been received from the client device;
selecting, based on the optimization factor, one from at least media file representing an identical media production but having differing media play-back qualities; and
presenting to a user of the client device a link to the media file which has been selected.

19. The computer program product according to claim 18, where in the presenting to the user of the client device a link to the media file includes presenting a link directly a media file to present to the user.

20. The computer program product according to claim 18, where in the presenting to the user of the client device a link to the media file includes presenting a link directly a media file that is compatible with a podcast.

21. The computer program product according to claim 18, where in the presenting to the user of the client device a link to the media file includes presenting a link to a content description file meta information about the media file.
